(19) United States
(12) Patent Application Publication
(10) Pub. No.: US 2004/0189008 A1
(43) Pub. Date: Sep. 30, 2004

(54) Magneto-turbine electric charging

(76) Inventor: Constantinos Tsatsis, Lynnfield, MA (US)

Correspondence Address: George E. Kersey, P.O. Box 1073, Framingham, MA, 01701, US

(21) Appl. No.: 10/396,244

(22) Filed: Mar. 26, 2003

(51) Int. Cl. H02P 9/04

(52) U.S. Cl. 290/1 A

(57) ABSTRACT

Method and apparatus for electrical storage and magneto-turbine charging, by having the turbine driven by pressure, supplemented by motor action, to operate a generator that produces electrical energy that is stored, for example in a battery to operate a motor vehicle; when the stored charge falls below a prescribed level the turbine is operated until the prescribed level stored charge is reached. The electrical storage thus produced may be used as an emergency source of electricity, for example, to provide power when a source, such as a public utility, in interrupted in an emergency.

### BACKGROUND OF THE INVENTION

This invention relates to electric charging and; more particularly, to the charging of electric storage devices, such as batteries, to supply energy at a prescribed level over a prolonged period for operating a vehicle or providing an emergency source of power, for example, for household use when public mains are interrupted.

The typical electric storage battery installed in a vehicle is used only for starting and lighting because the electrical energy stored in the battery is insufficient to operate the vehicle. Once the vehicle is started the further operation usually is by an internal combustion engine, which is a significant source of air pollution. Attempts have been made to power vehicles from alternative sources, but these have many drawbacks. Solar panels require such a large charging surface that they are presently unsuitable. Electric vehicles that use the ordinary recharge systems have a limited range of operation and require, frequent returns to electric charging stations.

For conventional electric vehicles, the travel range is about 100 miles, limiting their use to local urban travel. In order to obtain even this range, it is necessary to have a relatively large on-board battery and associated electrical drive motors. When the battery becomes discharged it is necessary to stop for a recharge the battery, which not only requires an appropriate charging facility but also, sufficient time for the recharge to take place.

While additional storage batteries could extend the range, this is undesirable because such batteries are heavy, bulky and require additional space. In addition, the added weight could reduce mileage efficiency, and additional time would be needed to recharge the additional batteries.

An alternative solution would be to store energy in a form that does not require the excessive weight of additional storage batteries. This can allow the range of vehicle operation to be extended without the need for frequent recharging and also would avoid the reduction in mileage efficiency associated with the weight of additional batteries.

In my prior invention of application Ser. No. 120478, filed Jul. 23, 1998, I used a tank of high pressure air to store sufficient energy that can provide for battery recharge by way of a turban and an electrical generator. The recharge is activated as the battery becomes discharged in order to keep the, battery fully charged. Other auxiliary equipment can extend a vehicles range further after initial battery charge and compressed air energy are exhausted. This involves the use of a small gasoline motor to keep the battery charged and the air tank pressurized. The gasoline motor can recharge the battery by driving the air compressor to re-pressurize the air tank and thus extend the range of the vehicle to what is limited by the amount of stored fuel. This extends the capability of electric powered vehicles without seeking to provide more efficient batteries.

Accordingly, it is an object of the invention to increase further the capability of an electric powered vehicle without seeking to provide more efficient batteries.

A related object of the invention is to produce greater still efficiency in automotive, propulsion. Another object of the invention is to limit the atmospheric pollutants associated with automotive propulsion.

Accordingly, it is an further object of the invention to overcome the problems of the prior art.

### SUMMARY OF THE INVENTION

In accordance with the invention, enhanced automotive propulsion is accomplished by regenerative feedback from a source of stored electrical energy, such as a battery, for which temperature and voltage are sensed to provide an output control signal for an air pressure tank. A gasoline engine timer/starter control for a compressor is provided with air pressure sensor information as in input, and an air controller meters air flow from the pressure tank.

The pressurized electric charging system of the invention employs a compressor that provide input to a storage tank from which compressed fluid is applied to a motorized turbine. The motorized turbine operates a generator which supplies electrical energy through a transmission to storage batteries through a control which is connectable to a converter. An alternative source of energy supply to the batteries can be provided from a main power source. The batteries supply drive energy to motors which are connected to the wheels of the vehicle. The charge on the batteries is indicated by a sensor which can activate a controller for a gasoline engine to operate the compressor, which also can be operated by an electric motor from the main power line.

The invention provides for storing electrical energy and operating a turbine by pressure and motor action to charge an electrical storage device, which can be a battery for providing an alternative source of electric power, including emergency power for household operation in the event of an interruption in public utility power and operating a motor vehicle.

In accordance with one aspect of the invention for automotive propulsion a source of fluid pressure operates a generator with its output applied to at least one wheel of a vehicle. The pressure of the source can be controlled to permit continued operation of the vehicle. The generator is operated from the source through a turbine, which can be supplemented by a magnetic drive provided by a drive motor.

The battery can be chargeable from an external source through a switch that permits the generator to be disconnected when the battery is to be charged externally, and the pressure of the source can be provided by a compressor which can be driven from the generator. Alternatively the compressor is controlled through a switch which permits a local gasoline engine to operate the compressor or permits an electric motor to operate the compressor through an external source of electric power.

In a method of the invention providing for automotive propulsion, the steps include (a) operating at least one wheel of a vehicle by an electric wheel motor, (b) connecting the wheel motor to a generator that supplies electrical energy, and (c) driving the generator from a source of fluid pressure through a motorized turbine.

The method further includes the step of energizing an auxiliary motor by the generator, wherein the motor has a magnetic component which reacts to a magnetic field produced by the electrical energy supplied by the generator.

In accordance with one aspect of the invention electrical storage is in a battery which is installable in a vehicle, and pressure is supplied from a store of compressed fluid, which can be gaseous, and the store of compressed fluid drives a motorized turbine which is connected to a generator.

The stored charge is monitored and electrical charges are generated when the stored charge falls below a prescribed level. The operation of generating electrical energy is terminated when the stored charge returns to a prescribed level.

In a method of the invention for fabricating electrical charging apparatus the steps include (a) providing means for storing electrical energy; and (b) providing means for pressure charging the electrical storage means through a motorized turbine.

For one aspect of the method the electrical storage is in a battery installed in a vehicle.

Pressure is from a store of compressed gaseous fluid, and electrical charges are generated from a pressure storage tank connected to a motorized turbine which is connected to a generator. The charge on the electrical store is monitored to operate the motorized turbine when the charge falls below a prescribed level, and the operation is terminated when the stored charge returns to a prescribed level.

### DESCRIPTION OF THE DRAWINGS

Other aspects of the invention will become apparent after considering several illustrative embodiments taken in conjunction with the drawings in which:

FIG. 1 is a block diagram of a pressurized electric charging system in accordance with the invention;

FIG. 2 is a schematic diagram showing the invention adapted for use in an electric vehicle;

FIG. 3 is a schematic diagram of a further alternative embodiment of the invention.

### DETAILED DESCRIPTION

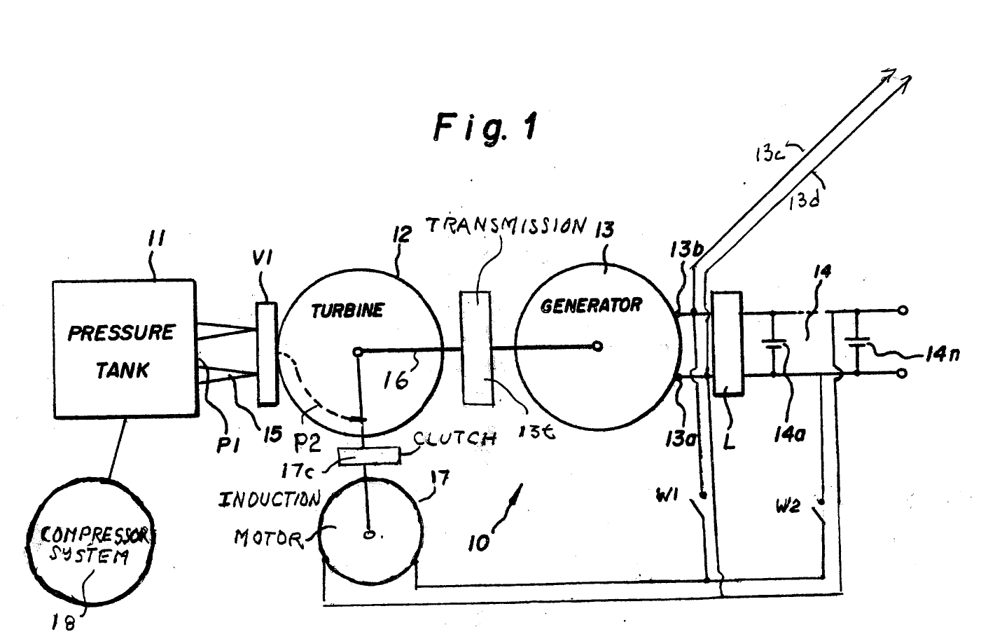

With reference to the drawings, the block diagram of FIG. 1 outlines the primary components of a pressurized electric charging system 10 of the invention, which includes a pressure tank 11, a turbine 12, a generator 13 that can be driven by an auxiliary motor 17, and an array 14 of batteries.

Interconnecting the pressure tank 11 and the turbine 12 is a venturi nozzle 15 which can, raise the pressure that is released from the tank 11 at an appropriate time interval as explained below. The turbine 12 is connected to the generator 13 through a transmission 13t in order to operate the generator 13 at an appropriate voltage output level. The generator 13 supplies its out directly to limiter L to provide a charging voltage of appropriate level to the battery bank 14. While a common battery voltage is 12 volts, lower and higher voltages can be used as well.

In addition, line 13c and 13d permit the output of the generator 13 to be used as an emergency supply. Thus when the mains to household are interrupted, for example during a hurricane or other emergency, the lines 13c and 13d can be connected to the household after disconnecting the lines to the mains.

When pressure P1 from the tank 11 is released through the venturi 15, and enters the turbine 12, the rotation of the turbine 12, because of the gas pressure P2 on its interior blades (not visible in FIG. 1), causes the rotation of the generator 13 by virtue of the coupling 16 of the respective shafts of the turbine 12 and the generator 13 through the transmission 13t which controls the rotation of the generator in relation to the turbine 12 in order to produce the desired voltage level at the output, terminals 13a and 13b.

To assist the rotation of the turbine 12 from the pressure tank 11, a clutch 17c is included between the induction motor 17 and turbine 12. The clutch 17c assures synchronization between the rotation of the turbine because of pressure from the tank 1I and the rotation of the induction motor 17. The field windings of the motor 17 can be energized from the output of the generator 13 through a switch W1, or from the battery bank 14 through a switch W2.

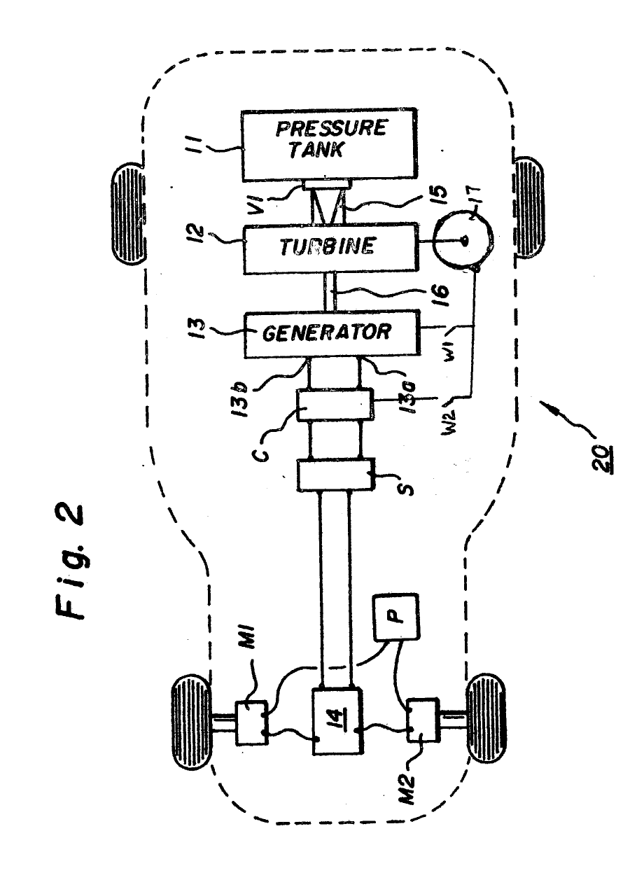

The pressure tank 11 can be charged either externally, when the system of FIG. 1 is installed in a unit, such as an automobile as shown in FIG. 2, or internally by the compressor system 18, which can take any number of known forms. The compressor system 18 can be a standard gasoline engine compressor using an ordinary internal combustion engine. However to avoid atmospheric pollution from an internal combustion engine, a fuel cell may be employed to operated an electrically driven compressor. Such a fuel cell, as is well known applies a substance, such as hydrogen, to one electrode, and oxygen to another electrode to permit electrical charges to flow between the electrodes. Where hydrogen, for example in tank form, is not available, any other well known substitute may be employed, as has been the case with the fuel cells employed by NASA, the National Space Administration. Suitable substitutes for hydrogen include methyl alcohol, hydrazine, or a simple hydrocarbon.

It will be understood that the turbine 12, the generator 13, the battery bank 14 and the induction motor 17 are each of conventional construction. In addition the transmission 13t and the clutch 17c are of conventional construction.

In FIG. 1, the voltage produced by the generator 13 is applied to the bank 14 of batteries 14a-14n. Accordingly, the generator 13 produces a Direct Current (DC) output. For that purpose the generator 13 may have a conventional magnetized rotor and a conventional stator winding which can supply additional magnetization to the rotor windings. The output is taken from the stator in conventional fashion. Similarly the induction motor 17 may have a magnetic stator or rotor with electrical energy to supply rotation applied to the rotor or stator.

It will be understood that other types of DC generator may be employed and that the generator 13 can produce Alternating Current (AC), as well as other forms of output, particularly when the system 10 of FIG. 1 is used as an emergency power source, for example to supply a household when emergency power is the only power available.

Accordingly, when pressure is released from the tank 11, for example through the venturi 15, by opening the control valve V1, the turbine 12 begins to rotate and a voltage appears across the terminals 13a and 13b. In order to facilitate the operation of the turbine 12, its operation can be joined by that of the induction motor 17, through the clutch 17c when the rotations are appropriate. It is convenient to use this generated voltage to charge the batteries of the bank 14, made up of individual parallel cells 14a-14n. In order to prevent the batteries from being overcharged, the lead 13a and 13b are connected to a voltage limiter L.

For the conventional lead acid battery in common use, normal voltage is 6 or 12 Direct Current volts. The charging voltage normally exceeds the nominal battery voltage, so that the generator 13 is limited to a voltage on the order of 7 or 14 volts, respectively.

When the battery array 14 is fully charged, the venturi outlet valve V1 is closed so that the charging voltage from the generator 13 is removed from the storage battery array 14. Once the batteries of the array 14 are fully charged, they can be used to supply direct current energy in conventional fashion.

One adaptation of the invention is illustrated in FIG. 2 where the system 10 of FIG. 1 is used in a vehicle 20, shown in dashed outline. The battery bank 14 of FIG. 1 becomes the storage battery assemblage 14 of the vehicle 20, and is used to supply Direct Current to motors M1 and M2 through a control panel P. The motors M1 and M2 provide front-wheel drive through respective axles connected to the front tires of the vehicle 20. The turbine 12 and generator 13 take the place of a conventional engine. The turbine can be motorized by the motor 17 by operating one of the switches W1 or W2.

Instead of having a fuel tank, or a bank of solar cells, the vehicle 20 includes the pressure tank 11 and the motorizable turbine 12 of the invention.

It is readily apparent that when the system 10 of the invention is used in a device, such as the vehicle 20, it provides definite advantages over other electrical systems, such as those provided by batteries required to be charged at an external charging source. In the case of the invention, the vehicle 20 carries with it a pressure tank source 11 for recharging its battery assemblage 14.

Thus, when the voltage level of the battery assemblage 14 in the vehicle 20 drops below a prescribed level, the energy stored in the pressure tank 11 can be used to bring the voltage of the battery assemblage 14 back to a desired level. Consequently, a driver does not need to be concerned when the voltage of his battery assemblage 14 falls to a level which, in the case of a conventional electric vehicle, requires a return to an external charging station. In the case of the invention, all that is needed is to release the pressure stored in the pressure storage tank 11 to operate the turbine 12 and the generator 13 to provide a suitable level of charge on the battery assemblage 14.

The recharging can be accomplished manually, or automatically. For manual operation a sensor in the control panel P monitors the battery assemblage voltage and indicates when recharging is needed. The operator can then open the valve V1 until the desired level of charge is attained. Operation of the valve V1 can be by solenoid action,

For automatic operation standard sensors, e.g. sensor S, are employed with the valve V1 and a comparator C which compares the voltage of the generator 13 with the voltage of the battery bank 14. When the comparator C senses that the battery voltage is less than needed, it opens the valve V1.

The turbine 12 is used in conjunction with the generator 13 to produce electrical power. Fluid power for the turbine 12 can be provided by a compressor system during those periods when the output generator level falls below a prescribed value.

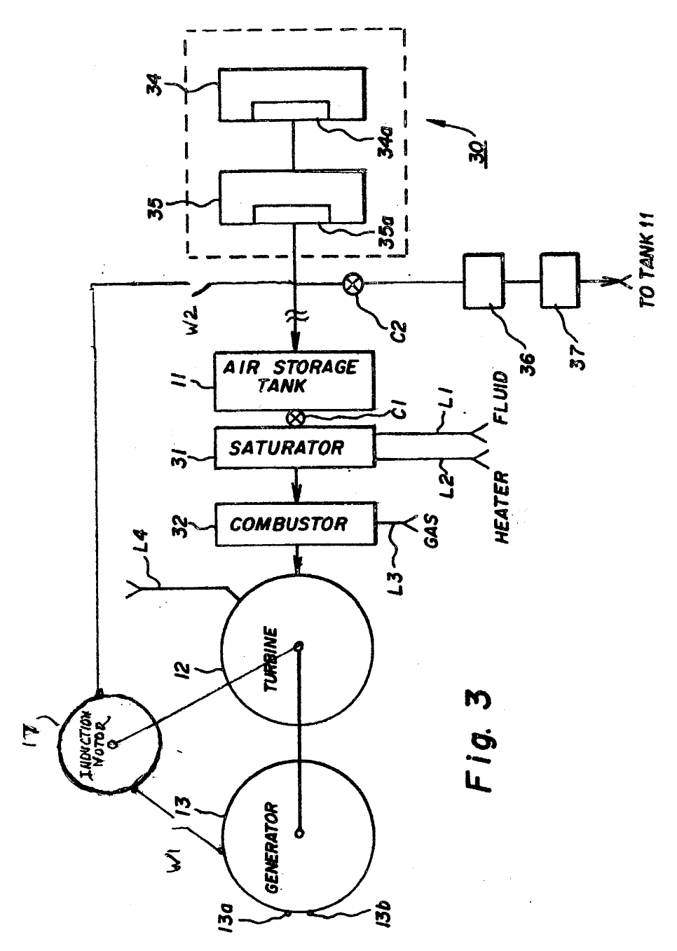

As indicated in FIG. 3, a separate compressor system 30 can be used to store fluid, such as air, in the pressure storage tank or chamber 11. The compressed fluid from the tank 11 is used during those intervals when the battery level is to be returned to its desired value. When the tank 11 is being pressurized, it can be disconnected from the turbine by operation of a control valve C1.

To pressurize the tank 11, the compressor system 30 includes a low pressure compressor 34 and a high-pressure compressor 35. Preferably the low pressure compressor 34 is coupled to an inter-cooler 34a to remove some of the thermal energy of compression. The continuous output of the high-pressure compressor 35 is preferably coupled to an after cooler 35a which removes additional thermal energy from the resultant continuously compressed air stream.

The thermal energy thus removed can be applied to a saturator. The resultant compressed air can flow directly to the tank 11, or, after opening of a control valve C2 can flow continuously and directly from the compressor system to a saturator 36 before being applied to a combustor 37. The saturator 36 is more effective if used in conjunction with an after cooler, which does not remove excessive thermal energy from the compressed airstream that exits the compressor system 30.

The compressed air stream produced by the compressor system 30 contains both mechanical and thermal energy. When processed through an after cooler, much of the thermal energy is withdrawn. This is required so that the compressed air will be cold enough to be compatible with a practical air storage tank. The air stream thus cooled is conveyed to the tank 11 to store the mechanical energy of the compressed air.

This mechanically stored energy is used when the compressor system 30 is shut down and a voltage level, such as that of the battery bank 14, is insufficient. This energy may be used in conjunction with fuel fed to the turbine through the combustor by line L3, or directly by line L4. More specifically, compressed air from the storage tank 11 can be conveyed to a combuster, such as the combustor 32, through an appropriate configuration of valves.

To enhance the efficiency of the system, a saturator 31 can be positioned between the storage tank 11 and a combustor 32, which can provide hot gas for driving the turbine 12. The saturator 31 receives compressed air from the storage tank 11 and simultaneously heats and humidifies it. Fluid for humidification can be supplied over line L1, and heater current can be applied over line L2, from, for example, the battery assemblage 14 of FIG. 1, or other source. The resulting heated and humidified compressed air is conveyed t6 the combuster 32.

Power production by the turbine 12 is enhanced by the combination of air storage and saturation, i.e. humidification and post storage heating. This combination yields a number of advantages. It enables the continuous operation of a battery system, such as the assemblage 14 of FIGS. 1 and 2.

By conveying a pressurized air steam from the storage tank 11 to the saturator 31, the turbine 12 can receive a heated and humidified gaseous stream with greater mass flow and greater thermal energy. This provides the saturator with a reduced amount of needed energy and thus a reduction in any required fuel. Consequently, the invention can reduce undesirable emissions.

A specific embodiment of an enhanced system in accordance with the invention contains a combination of air storage, fuel processing and “saturation” by simultaneous heating and humidification of air.

A motor (not shown) drives the compressor system 30. The thermal energy of the compressed air stream is removed by heating water in an inter-cooler and after-cooler, and the heated water can be conveyed to a hot water storage tank.

Cooling may also be provided to reduce some of the water temperature in the inter-cooler and in the after-cooler. Some of the compressed air stream produced by the system 30 can be conveyed directly through an open valve to the tank 11, while the remainder can go directly to the saturator 36 through an open valve C2.

The system is preferably sized to compress more air while “on” than is consumed by the turbine 12. Over time, the air storage and withdrawal can remain in balance. Thus, the air storage tank 11 serves to conserve the mechanical energy of compressed air, and the thermal energy not removed by an after cooler. A hot water tank can store much of the energy of compression. These sources of energy may be used in accordance with the invention with the mechanical energy used at time periods when it is necessary to recharge the battery bank 14.

While preferred embodiments have been shown and described, it is to be understood that changes in details of construction and method from what has been illustrated may be, made without departing from the spirit and scope of the invention as defined by the foregoing appended claims.

What is claimed:

1. Apparatus comprising
means for storing electrical energy; and
pressure means for operating a turbine to charge the electrical storage means;
wherein the operation of said turbine is supplemented by motor action.

2. Apparatus as defined in claim 1 wherein said electrical storage means comprises a battery for providing an alternative source of electric power, including emergency power for household operation in the event of an interruption in public utility power.

3. Apparatus as defined in claim 2 wherein said battery is installed to supply motive power for a vehicle, including automobiles.

4. Apparatus as defined in claim 1 wherein said compressed fluid is air produced by a compressor system, and said motor action supplementing the operation of said turbine is through a clutch.

5. Apparatus as defined in claim 4 wherein said pressure means includes means for generating electrical charges and said compressor system includes a low-pressure compressor and a high-pressure compressor.

6. Apparatus as defined in claim 4 wherein said means for generating electrical charges comprises a pressure storage source for driving a turbine which also is driven by said motor.

7. Apparatus as defined in claim 6 wherein the charges on said electrical storage means are monitored and said means for generating electrical charges is operated when said charge on said electrical storage means falls below a prescribed level and the generating means is connected to a transmission.

8. Apparatus as defined in claim 7 wherein the operation of said means for generating electrical energy is terminated when said charge on said electrical storage means returns to said prescribed level and said compressor system includes a saturator and a combustor.

9. A method of electrical charging comprising
storing electrical energy in electrical storage means; and
charging said electrical storage means by motor means and means for storing compressed fluid.

10. The method of claim 9 including storing electrical energy in a battery charged by a generator driven from a motorized turbine through a transmission.

11. The method of claim 10 including installing said battery in a vehicle to supply motive power therefore and charging said means for storing compressed fluid through a compressor system.

12. The method of claim 9 including storing compressed air in said pressure means by said compressor system.

13. The method of claim 9 wherein said compressed fluid originates in a low-pressure compressor of said compressor system.

14. The method of claim 13 wherein said pressure means includes means for generating alternating current electrical charges for providing emergency power.

15. The method of claim 14 wherein said means for generating electrical charges comprises a pressure storage tank connected to a turbine which is connected to a generator having a conventional magnetized rotor and a conventional stator winding which supplies additional magnetization to the rotor windings.

16. The method of claim 15 wherein the charge on said electrical storage means is monitored and said means for generating electrical charges is operated when said charge on said electrical storage means falls below a prescribed level.

17. The method of claim 16 wherein the operation of said means for generating electrical energy is terminated when said charge on said electrical storage means returns to said prescribed level.

18. A method of fabricating electrical charging apparatus comprising the steps of;
(a) providing means for storing electrical energy; and
(b) providing means for pressure charging the electrical storage means by a compressed gaseous fluid operating a motorized turbine.

19. The method of claim 18 wherein said electrical storage means comprises a battery for moving a vehicle, said pressure means comprises means for storing a compressed gaseous fluid and includes means for generating electrical charges from a pressure storage tank connected to a turbine which is connected to a generator, and the charge on said electrical storage means is monitored to operate when said charge on said electrical storage means falls below a prescribed level, and the operation of said means for generating electrical energy is terminated when said charge on said electrical storage means returns to said prescribed level.
